(19) United States
(12) Patent Application Publication
(10) Pub. No.: US 2021/0217115 A1
(43) Pub. Date: Jul. 15, 2021

(54) SYSTEM AND METHOD FOR MATCHING DATA INPUTS TO MODULES FOR COMPATABILITY ANALYSIS

(71) Applicant: Stoa USA, Inc, North Miami Beach, FL (US)

(72) Inventors: Or AGASSI, Scottsdale, AZ (US); Jonathan SARAGOSSI, Tel Aviv (IL)

(73) Assignee: Stoa USA, Inc, North Miami Beach, FL (US)

(21) Appl. No.: 17/144,410

(22) Filed: Jan. 8, 2021

Related U.S. Application Data
(60) Provisional application No. 62/958,912, filed on Jan. 9, 2020.

(51) Int. Cl. G06Q 50/18; G06Q 50/16

(52) U.S. Cl. CPC G06Q 50/188; G06Q 50/167

(57) ABSTRACT

A system and method for compatibility analysis using clustered data. A method includes clustering a plurality of underwriting criteria indicated in underwriting criteria data with respect to a plurality of modules, wherein each underwriting criterion of the plurality of underwriting criteria is clustered into a respective module of the plurality of modules; generating a unified module based on the plurality of modules; applying the unified module to the plurality of underwriting criteria, wherein the unified module outputs a unified score for the plurality of modules; and generating a compatibility level score between a first entity and a second entity based on at least one requirement of the first entity, at least one dataset storing entity characteristics of a plurality of entities including the second entity, and the unified score output by the unified module.

### CROSS-REFERENCE TO RELATED APPLICATIONS

This application claims the benefit of U.S. Provisional Application No. 62/958,912 filed on Jan. 9, 2020, the contents of which are hereby incorporated by reference.

### TECHNICAL FIELD

The present disclosure relates generally to data processing, and more specifically to matching data inputs to appropriate modules to improve accuracy and efficiency of data processing.

### BACKGROUND

In the field of data processing, providing appropriate data to modules can result in better processing. This improvement is particularly important when large amounts of data are involved. Real-estate investors are always looking for the next best investment. However, in most cases, a good and profitable real-estate transaction may be difficult to find among thousands of potential transactions.

Some real-estate transactions are based on purchasing a revenue-generating asset and quickly reselling it for profit. In such projects, also referred to as flipping, profit is generated either through the price appreciation that occurs as a result of an increase of the housing market, demographic trendiness, and/or from developments and renovations.

Refurbishment companies operating in this field often borrow funds from lenders for purchasing and renovating the real-estate properties. Such lenders, who provide loans for refurbishment companies, may encounter difficulties in assessing the actual risks involved in such projects. Another difficulty lenders encounter is finding transactions that suit their requirements, i.e., a suitable credit product. Such requirements may refer to the borrowing entity's characteristics, property's characteristics, and so on. When a vast number of potential real-estate transactions are available and an enormous number of borrowing entities seek for funding, the challenge increases. Although lenders may find transactions that suit their requirements, timely finding the optimal transaction is still a challenge.

Existing solutions present ways for managing and monitoring loans, automatically approving loans, matching between lenders and borrowers, and so on. However, a solution that permits matching between lenders and credit products that are associated with real-estate properties is still needed.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for compatibility analysis using clustered data. The method comprises: clustering a plurality of underwriting criteria indicated in underwriting criteria data with respect to a plurality of modules, wherein each underwriting criterion of the plurality of underwriting criteria is clustered into a respective module of the plurality of modules; generating a unified module based on the plurality of modules; applying the unified module to the plurality of underwriting criteria, wherein the unified module outputs a unified score for the plurality of modules; and generating a compatibility level score between a first entity and a second entity based on at least one requirement of the first entity, at least one dataset storing entity characteristics of a plurality of entities including the second entity, and the unified score output by the unified module.

Certain embodiments disclosed herein also include a non-transitory computer readable medium having stored thereon causing a processing circuitry to execute a process, the process comprising: clustering a plurality of underwriting criteria indicated in underwriting criteria data with respect to a plurality of modules, wherein each underwriting criterion of the plurality of underwriting criteria is clustered into a respective module of the plurality of modules; generating a unified module based on the plurality of modules; applying the unified module to the plurality of underwriting criteria, wherein the unified module outputs a unified score for the plurality of modules; and generating a compatibility level score between a first entity and a second entity based on at least one requirement of the first entity, at least one dataset storing entity characteristics of a plurality of entities including the second entity, and the unified score output by the unified module.

Certain embodiments disclosed herein also include a system for compatibility analysis using clustered data. The system comprises: a processing circuitry; and a memory, the memory containing instructions that, when executed by the processing circuitry, configure the system to: cluster a plurality of underwriting criteria indicated in underwriting criteria data with respect to a plurality of modules, wherein each underwriting criterion of the plurality of underwriting criteria is clustered into a respective module of the plurality of modules; generate a unified module based on the plurality of modules; apply the unified module to the plurality of underwriting criteria, wherein the unified module outputs a unified score for the plurality of modules; and generate a compatibility level score between a first entity and a second entity based on at least one requirement of the first entity, at least one dataset storing entity characteristics of a plurality of entities including the second entity, and the unified score output by the unified module.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a schematic diagram of a compatibility analyzer according to an embodiment.

FIG. 3 is a flowchart illustrating a method for generating compatibility level scores using modules according to an embodiment.

FIG. 4 is a flowchart illustrating a method for generating compatibility level scores using modules according to another embodiment.

FIG. 5 is a flowchart describing a method for generating a unified module by matching data to corresponding modules according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The disclosed embodiments provide an efficient, automatic, and accurate matching between a lender having one or more requirements for providing a loan to a borrowing entity, and at least one credit product that is associated with one or more real-estate properties. More specifically, the disclosed embodiments utilize a unified module generated based on multiple modules matched to appropriate data such that the unified module provides more accurate and efficient results. The unified module is created by clustering underwriting criteria representing the requirements into appropriate modules and generating the unified module based on the modules having the clustered data. The unified module is utilized for the matching, thereby resulting in a more accurate and efficient match. Credit product that is associated with a real-estate property generally includes information such as the real-estate property's characteristics, the borrowing entity's characteristics, loan's characteristics, and the like.

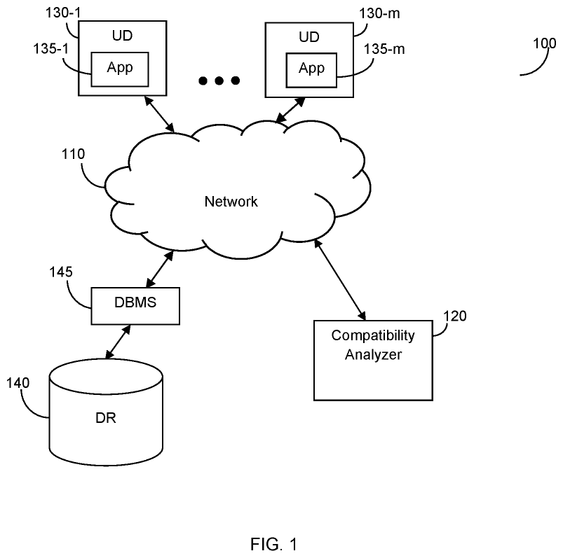

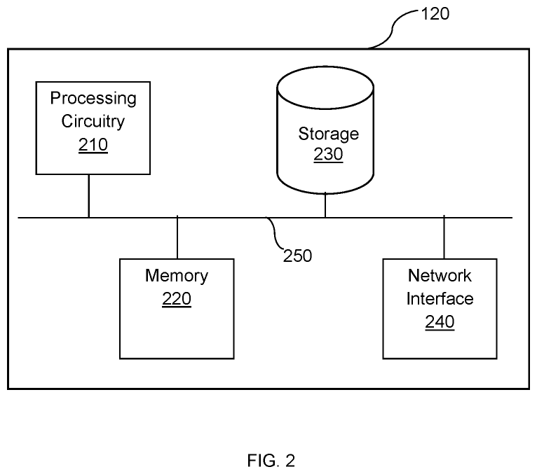

FIG. 1 is a network diagram 100 utilized to describe the various disclosed embodiments. A network 110 is used to communicate between different networked components. The network 110 may be the Internet, the world-wide-web (WWW), a local area network (LAN), a wide area network (WAN), a metro area network (MAN), and other networks capable of enabling communication. A compatibility analyzer 120 communicates via the network 110. The compatibility analyzer 120 is described in more detail with respect to FIG. 2.

One or more user devices (UD) 130-1 through user device 130-m, referred to individually as user device 130 and collectively as user devices 130, may communicate with the compatibility analyzer 120 via the network 110. A user device 130 may be, for example, a smart phone, a mobile phone, a laptop, a tablet computer, a wearable computing device, a personal computer (PC), a smart television, and other kinds of computing devices equipped with browsing, viewing, capturing, storing, listening, filtering, and managing capabilities enabled as further discussed herein. The user device 130 may be configured to send to and receive from the compatibility analyzer 120 data, metadata, datasets, and the like. Each user device 130 may further include a respective software application (App) 135 installed thereon. The software applications 135 may be downloaded from an application repository, such as the AppStore®, Google Play®, or any repositories hosting software applications. The respective application 135 may be pre-installed in each user device 130. In some implementations, the application 135 is a web-browser.

One or more data repositories (DR) 140, referred to individually as data repository 140 and collectively as data repositories 140, may communicate with the compatibility analyzer 120 via the network 110 (shown), or be embedded within the compatibility analyzer 120 (not shown). The data repository 140 may be communicatively connected to the network 110 through a database management service (DBMS) 145. The data repository 140 may be, for example, a storage device containing a database, a data warehouse, and the like. The data repository 140 may be used for storing datasets, data, metadata, combinations thereof, and the like.

In an embodiment, the compatibility analyzer 120 receives, from an electronic device (e.g., the user device 130) that is associated with a lender, at least one requirement for establishing a loan for purchasing at least one real-estate property. A lender may be, for example, a person, a lending company, a bank, and so on. In an embodiment, an electronic request that includes the at least one requirement for establishing a loan for purchasing at least one real-estate property, may be sent from the electronic device (e.g., the user device 130) that is associated with the lender to the compatibility analyzer 120.

The at least one requirement for establishing a loan for purchasing at least one real-estate property includes parameters such as, but not limited to, type of property, property's price range, loan payback period, borrowing entity's characteristics, loan-to-value (LTV) (which represents the ratio of a loan to the value of a property purchased), and so on. As a non-limiting example, a request is received from a user device 130-2 that is associated with a bank. According to this example, the request includes three requirements of the bank for providing a loan to be used to purchase a real-estate property. In this example, the four requirements are: (a) the property must be located in Florida, USA; (b) the property's value must be between USD 80,000 to USD 150,000; (c) the desired loan payback period is less than six months; and (d) the LTV is 70.

In an embodiment, the compatibility analyzer 120 is configured to extract, based on the at least one requirement, a first electronic dataset of a plurality of real-estate properties. The first electronic dataset includes at least a set of property's characteristics of each of the real estate properties. The first electronic dataset may include information indicating, e.g., the property's location, the weather at the property's area, the property's external current condition, the property's internal current condition, environmental data that is associated with the property, the property's value, the requested loan's amount, the requested loan payback period, real-estate market condition at the property's area, and so on.

As a non-limiting example, the dataset of a property may indicate that severe weather is about to occur at the area in which the property is located. Such severe weather may interrupt the refurbishment process of the real-estate property and therefore may cause a hindrance in completing the refurbishment. In this example, such a hindrance may make it difficult to sell the property as planned, and as a result the loan may not be returned as scheduled.

In another embodiment, the first electronic dataset may include multimedia that is associated with the property and therefore may more specifically indicate the condition of the property than data simply describing the property. In yet another embodiment, the first electronic dataset may include an inspector report that includes a plurality of parameters such as, but not limited to, the property's internal condition, external condition, faults, combinations thereof, and the like.

In an embodiment, the compatibility analyzer 120 is configured to search for and extract datasets that are associated with real-estate properties based on the indicated requirements. Thus, datasets of irrelevant real-estate properties, according to the at least one requirement, are not extracted. The process of filtering and extracting only such datasets that are associated with relevant real-estate properties out of an enormous number of potential real-estate properties, may contribute at least to the purpose of reducing search time, use of computing resources for searching, and the like.

In an embodiment, the compatibility analyzer 120 is configured to extract a second electronic dataset of a plurality of potential borrowing entities. A potential borrowing entity may be a person, a partnership, a company, or any other entity that is looking for a loan for purchasing a real-estate property. Each potential borrowing entity of the plurality of potential borrowing entities may be associated with at least a real-estate property of the plurality of real-estate properties. To this end, the second electronic dataset is extracted based on the at least one requirement of the lender. For example, when the requirements include the property being in Florida, USA, one of the potential borrowing entities is associated with a particular house that is located in Miami, Fla., USA.

The second electronic dataset includes at least a set of borrowing entity's characteristics of each of the plurality of potential borrowing entities. The second electronic dataset may include information indicating, for example, the borrowing entity's type (e.g., whether it is a person, a company), the borrowing entity's historical repayment patterns, historical loan defaults of the borrowing entity, credit status, background check, bank statements, the area at which the borrowing entity usually operates, and so on. The second electronic dataset may further include information indicating the profits made by the borrowing entity in each recorded historical refurbishment project of a real-estate property. Such information regarding the profits may be indicative of the borrowing entity's professionalism and may therefore be a good indicator of the probability that the borrowing entity will return the borrowed money on time.

In an embodiment, the compatibility analyzer 120 is configured to analyze the at least one requirement, the first electronic dataset, and the second electronic dataset. In an embodiment, the analysis may be achieved by applying one or more predetermined compatibility scoring rules to the at least one requirement, the first electronic dataset and the second electronic dataset. The compatibility scoring rules may be, for example, mathematical rules for calculating a score referring to the compatibility level between the lender (e.g., lender's requirements) and a credit product that is associated with at least one real-estate property based on the at least one requirement, the first electronic dataset and the second electronic dataset, as further discussed herein below.

As a non-limiting example, a compatibility level score between the lender and at least one credit product that is associated with a certain real-estate property is calculated as a relatively low score because a hurricane is expected to hit the area at which the real-estate property is located in two weeks. This may occur despite the property's location, value, loan payback period, and LTV meeting the required range of the lender according to the at least one requirement.

In a further embodiment, the analysis may be achieved using one or more machine learning techniques. For example, a machine learning model may be applied to the at least one requirement, the first electronic dataset, and to the second electronic dataset. The machine learning model is trained based on historical lender and borrowing entity datasets and requirements, and may be trained using supervised learning by including training compatibility level scores among the training data.

In an embodiment, the compatibility analyzer 120 is configured to generate, based on the result of the analysis, at least one compatibility level score between the lender and at least one credit product that is associated with at least one real-estate property of the plurality of real-estate properties. The compatibility level score indicates the degree of matching between the lender and a credit product that is associated with a real-estate property.

A credit product may include all the terms and obligations of the form of credit (e.g., a loan) under which the lender agrees to lend funds to the borrowing entity. The credit product may include, but is not limited to, the loan's characteristics, e.g., the loan amount should be between USD 40,000-USD 180,000. The credit product may also include the LW, e.g., the LTV of a first credit product may be up to 70% while a LTV of a second credit product may be up to 90%. The credit product may also include the type of the borrowing entity.

It should be noted that more than one credit product may suit the lender according to the lender's requirements. However, a first credit product may be more profitable to the lender, involve less risk, and the like, as compared to other credit products, and therefore the compatibility level score between the lender and the first credit product will be higher than those of other credit products. A plurality of predetermined credit products may be stored in a database from which each credit product of the plurality of credit products may be searched and retrieved by the compatibility analyzer 120 for the purpose of generating the at least one compatibility level score.

In an embodiment, upon generating the at least one compatibility level score, the compatibility analyzer 120 is configured to send a notification to the electronic device (e.g., the user device 130) of the lender. The notification may indicate the compatibility level score between the credit product that is associated with at least one real-estate property and the lender.

In an embodiment, the compatibility analyzer 120 receives one or more underwriting criteria. The underwriting criteria may include, for example, a requirement that the borrower will be at least 25 years of age, have a minimum cash reserves of $30,000, and the like. The compatibility analyzer 120 may be configured to analyze the one or more underwriting criteria. The analysis may be achieved by applying one or more extraction rules to the one or more underwriting criteria in order to extract relevant underwriting criteria for clustering. As a non-limiting example, a rule may dictate that textual elements which are identified in the received one or more underwriting criteria are extracted and utilized for clustering the one or more underwriting criteria, as further discussed herein below.

Based on the analysis, the compatibility analyzer 120 is configured to cluster each of the one or more underwriting criteria to a corresponding module associated therewith as described further herein below. For example, a cash reserve criterion may be automatically clustered to a minimum reserves' module, an age criterion may be automatically clustered to a minimum age requirement module, and the like. In a further embodiment, when a certain requirement does not fit an existing module, a newly module is generated for the requirement. To this end, the compatibility analyzer 120 is configured to match the underwriting criteria data to appropriate modules, thereby allowing for clustering the underwriting criteria data based on this matching.

In an embodiment, the compatibility analyzer 120 is configured to generate, based on the clustering of the underwriting criteria data with respect to the one or more modules, a unified module representing a unified modular underwriting scheme. The unified modular underwriting scheme enables generalization of a plurality of different criteria. The compatibility analyzer 120 is configured to implement the unified modular underwriting scheme to match loans corresponding thereto. Upon identification of a potential loan, the compatibility analyzer 120 is configured to extract data associated with the loan in order to determine whether the potential loan meets the input underwriting requirements.

FIG. 2 shows an example schematic diagram of a compatibility analyzer 120 according to an embodiment. The compatibility analyzer 120 includes a processing circuitry 210. In an embodiment, the processing circuitry 210 includes, or is a component of, a larger processing unit implemented with one or more processors. The processing circuitry 210 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The processing circuitry 210 is coupled via a bus 250 to a memory 220. The memory 420 may be volatile (e.g., random access memory, etc.), non-volatile (e.g., read only memory, flash memory, etc.), or a combination thereof. The memory 220 further includes a memory portion 222 containing instructions that, when executed by the processing circuitry 210, performs at least a portion of the disclosed embodiments. The memory 220 may be further used as a working scratch pad for the processing circuitry 210, a temporary storage, and others, as the case may be.

The processing circuitry 210 may be coupled to a network device 240, such as a network interface card, for providing connectivity between the compatibility analyzer 120 and a network, such as the network 110, discussed in more detail with respect to FIG. 1.

The processing circuitry 210 may be further coupled with a storage 230. In one configuration, software for implementing one or more embodiments disclosed herein may be stored in the storage 230. In another configuration, the memory 220 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 210, cause the processing circuitry 210 to perform the various processes described herein.

The storage 230 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 240 allows the compatibility analyzer 120 to communicate with, for example, the user devices 130, the data repository 140, both, and the like.

It should be understood that the embodiments described herein are not limited to the specific architecture illustrated in FIG. 2, and other architectures may be equally used without departing from the scope of the disclosed embodiments.

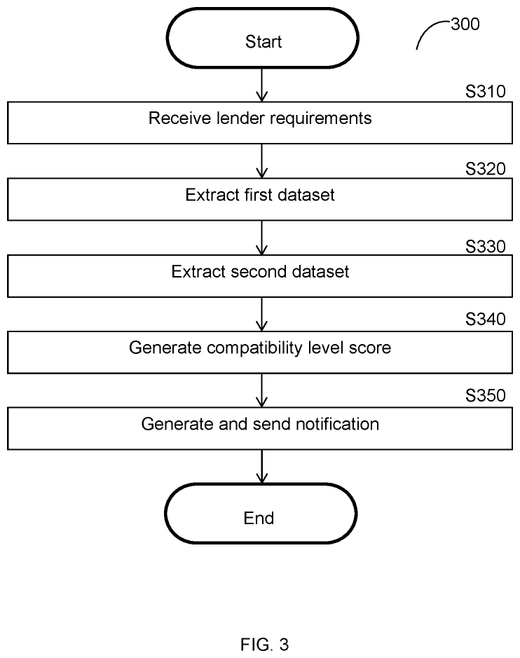

FIG. 3 is a flowchart 300 illustrating a method for generating compatibility level scores using modules according to an embodiment. The method of FIG. 3 is utilized to generate a compatibility level score between a lender and at least one credit product, where each credit product is associated with one or more real-estate properties (e.g., the credit product may be a loan needed to secure funding by a buyer in order to purchase the real-estate property). In an embodiment the method may be executed by the compatibility analyzer 120, FIG. 2.

At S310, at least one lender requirement for establishing credit for purchasing at least one real-estate property is received. The at least one lender requirement may be sent from an electronic device, e.g., a personal computer, that is associated with a potential lender.

At S320 based on the at least one requirement, a first electronic dataset of a plurality of real-estate properties is extracted. The first electronic dataset includes at least a set of real-estate property's characteristics of each of the plurality of real-estate properties as further discussed herein above with respect to FIG. 1.

At S330, a second electronic dataset of a plurality of potential borrowing entities is extracted. Each potential borrowing entity of the plurality of potential borrowing entities is associated with at least a real-estate property of the plurality of real-estate properties. The second electronic dataset includes at least a set of borrowing entity's characteristics of each of the plurality of potential borrowing entities.

At S340, an analysis of the at least one requirement, the first electronic dataset and the second electronic dataset is performed in order to generate at least one compatibility level score. In an embodiment, the analysis is achieved by applying one or more predetermined rules to the at least one requirement, the first electronic dataset and the second electronic dataset. Based on the result of the analysis, at least one compatibility level score is generated. The compatibility level score indicates the matching level between the lender and at least one credit product that is associated with at least one real-estate property of the plurality of real-estate properties.

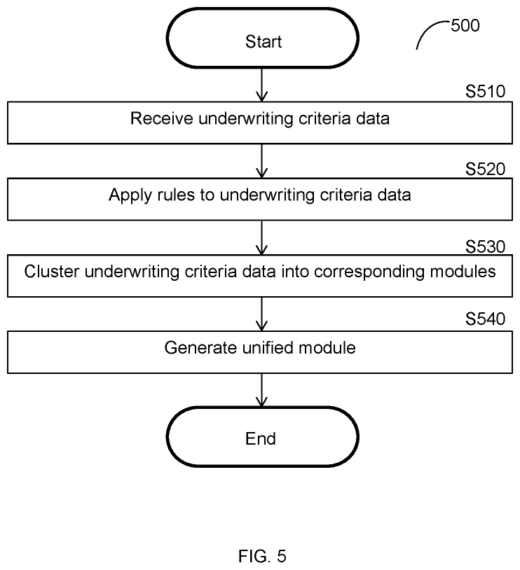

In an embodiment, S340 further includes clustering underwriting criteria into appropriate modules and generating a unified module using the modules having the respective clustered data, for example, as described below with respect to FIG. 5. The unified module is applied to the requirements and the datasets, and the output of the unified module is used as an input for generating the compatibility scores. To this end, the output of the unified module is a risk score to which the predetermined rules are applied along with the requirements and the datasets.

In a further embodiment, S340 further includes applying a machine learning model to the at least one requirement, the first electronic dataset, the second electronic dataset, and the unified risk score output by the unified module. The machine learning model is trained based on historical lender and borrowing entity datasets and requirements, and may be trained using supervised learning by including training compatibility level scores among the training data.

At optional S350, a notification is generated. In an embodiment, the notification indicates the generated compatibility level scores. In a further embodiment, S350 may further include determining whether the lender and the respective credit product (and associated real-estate property) are compatible based on the compatibility scores and a threshold, and only indicating compatible credit products in the notification. To this end, only credit products for which compatibility level scores are above a threshold (e.g., a predetermined threshold) are determined as compatible.

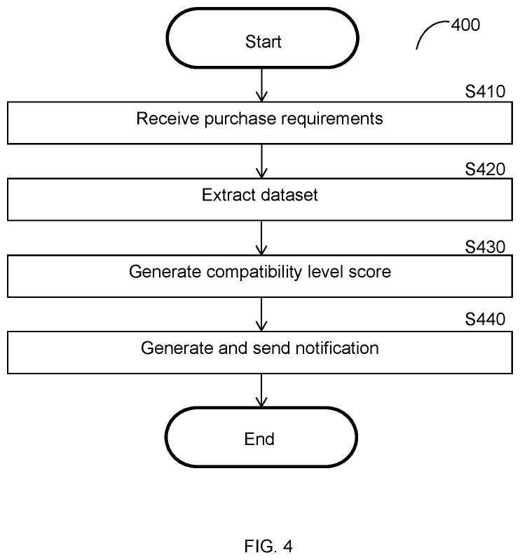

FIG. 4 is an example flowchart 400 illustrating a method for generating compatibility level scores using modules according to an embodiment. The method of FIG. 4 may be utilized to generate a compatibility score between a potential buyer and at least one real-estate property. In an embodiment, the method may be executed by the compatibility analyzer 120, FIG. 2.

At S410, at least one purchase requirement for purchasing at least one real-estate property is received. The at least one purchase requirement may be sent over an electronic notification from an electronic device that is associated with a potential buyer of at least one real-estate property. A potential buyer may be for example, a person, a company, a bank, and so on.

In an embodiment, an electronic request that includes the at least one requirement for purchasing at least one real-estate property, may be sent from the electronic device (e.g., the user device 130 of FIG. 1) that is associated with the potential buyer, to a computing device (e.g., the compatibility analyzer 120 of FIG. 1). The at least one requirement may be defined with respect to parameters such as, but not limited to, property type, property's value range thresholds, annual return, expected rent, and so on. As a non-limiting example, an electronic request is received from an electronic device that is associated with a potential buyer. The electronic request includes three requirements of the potential buyer indicates for a real-estate property with respect to a real-estate property: (a) the property must be located in Phoenix, Ariz., USA; (b) the property's value must be between USD 60,000 to USD 75,000; and (c) the annual return is more than 8%.

At S420 based on the at least one requirement, a first electronic dataset of a plurality of real-estate properties is extracted. The first electronic dataset includes at least a set of real-estate property's characteristics of each of the plurality of real-estate properties.

The first electronic dataset may include information indicating, for example, the property's location, the weather at the property's area, the property's external current condition, the property's internal current condition, environmental data that is associated with the property, the property's current value, real-estate market condition at the property's area, and so on. As a non-limiting example, the first dataset of a property may indicate that the refurbishment of the property is behind schedule. As another non-limiting example, the first dataset of a property may indicate a list of items that were replaced or added during the refurbishment of the property.

In another embodiment, the first electronic dataset may include multimedia that is associated with the property and may therefore better indicate the condition of the property. According to another embodiment, the first electronic dataset may include an inspector report that includes many types of parameters, such as the property's internal condition, external condition, faults, combinations thereof, and the like.

At S430, the at least one requirement and the first electronic dataset is analyzed. In an embodiment, the analysis includes applying one or more predetermined rules to the at least one requirement and the first electronic dataset. A predetermined rule may be, for example, a mathematical rule for calculating a compatibility level score based on the at least one requirement and the first electronic dataset. As a non-limiting example, a compatibility level score between the potential buyer and a specific real-estate property may be determined to be a relatively low score even though the property's price and the property's location are within the required range of the potential buyer because the property's internal condition is in poor shape, and therefore although the average annual return for properties in the neighborhood is 10%, a massive and expensive refurbishment is required to get to the average annual return.

Based on the result of the analysis, a compatibility level score is generated. The compatibility level score indicates the matching level between the potential buyer and at least one real-estate property. It should be noted that more than one property may suit the potential buyer, based on the potential buyer's requirements. However, a first property may be more profitable to the potential buyer and/or involve less risk compared to other properties, and therefore the compatibility level score between the potential buyer and the first property will be relatively high.

In an embodiment, S430 further includes clustering underwriting criteria into appropriate modules and generating a unified module using the modules having the respective clustered data, for example, as described below with respect to FIG. 5. The unified module is applied to the requirements and the datasets, and the output of the unified module is used as an input for generating the compatibility scores. To this end, the output of the unified module is a risk score to which the predetermined rules are applied along with the requirements and the datasets.

In a further embodiment, S430 further includes applying a machine learning model to the at least one requirement, the first electronic dataset, and the unified risk score output by the unified module. The machine learning model is trained based on historical potential buyer and real-estate entity datasets and requirements, and may be trained using supervised learning by including training compatibility level scores among the training data.

At optional S440, a notification may be sent to the electronic device (e.g., the user device 130 of FIG. 1) of the potential buyer. The notification may indicate the generated compatibility level scores. In a further embodiment, the notification may only indicate compatible real-estate properties. A compatible real-estate property may be, for example, a real-estate property having a compatibility level score above a predetermined threshold.

FIG. 5 depicts an example flowchart 500 describing a method for generating a unified module by matching data to corresponding modules according to an embodiment. In an embodiment the method described is executed by the compatibility analyzer 120, FIG. 2.

At S510, underwriting criteria data is received. The underwriting criteria data indicates underwriting criteria for providing credit related to a purchase of a real-estate property. The underwriting criteria data may be electronically received from a user device, e.g., the UD 130. The underwriting criteria may include, but is not limited to, a minimum age, a minimum cash reserve, combinations thereof, and the like.

In an embodiment, S510 includes applying one or more extraction rules to the one or more underwriting criteria in order to extract relevant underwriting criteria for each module. The extraction rules may be predetermined rules defining common underwriting criteria, for example, with respect to characteristics of the underwriting criteria data such as key terms, numerical values, special characters, combinations thereof, and the like. As a non-limiting example, the extraction rules may define an age as a numerical value in combination with the term “years,” “old,” or both.

In this regard, it is noted that different entities which provide credit products utilize different combinations of underwriting criteria. As a result, underwriting criteria from different entities cannot be analyzed using the same set of modules without reducing the accuracy and efficiency of processing by those modules. More specifically, when underwriting criteria indicated in different datasets vary, applying modules to all underwriting criteria data would require each module processing the entire set of data including data that is irrelevant to that particular module and may therefore produce less accurate results. By extracting and utilizing relevant underwriting criteria, applying modules to that data can be performed more efficiently and accurately.

At S520, the plurality of underwriting criteria is analyzed to enable clustering each of the plurality of underwriting criteria into an appropriate corresponding module. The analysis may be achieved using, e.g., a set of rules, as further discussed herein above with respect to FIG. 1.

At S530, each of the plurality of underwriting criteria is clustered into a corresponding module based on the analysis. A module may be associated with a certain category of requirements of a lender such as, but not limited to, an age module, a minimum reserves' module, and the like. The underwriting criteria are clustered into modules based on the content of the underwriting criteria data indicating each underwriting criterion. Thus, as non-limiting examples, a cash reserve criterion may be automatically clustered to a minimum reserves' module, an age criterion may be automatically clustered to a minimum age requirement module, and the like. It should be noted that when a received requirement does not fit an existing module, a new module may be generated respective thereof.

At S540, a unified module representing a unified modular underwriting scheme is generated. The unified module aggregates the clustered underwriting criteria such that the output of the unified module reflects a unified risk score for different modules. Such a unified risk score may therefore be utilized to calculate a compatibility score which effectively accounts for risk as part of compatibility.

The unified module is generated based on at least one module to which at least one underwriting criterion was clustered. The unified module enables generalization of a plurality of different criteria. As further discussed herein above, the unified module may be matched to credit products in order to generate compatibility scores and, therefore, to identify compatible credit products for a given lender. Upon identification of a potential credit product, underwriting criteria associated with the credit product is extracted in order to determine whether the potential loan meets the input underwriting requirements.

As a non-limiting example, when various underwriting criteria were clustered into modules related to cash reserves, flipper experience, and property location, respectively, a unified module is generated based on these collective modules. Underwriting criteria data is aggregated and input to the unified module in order to generate compatibility scores which reflect a unified risk profile related to a credit property for a given real estate property in light of these modules. The unified module therefore provides a more holistic analysis of underwriting criteria that can effectively account for multiple types of underwriting criteria which, in turn, improves accuracy of compatibility level score calculation. Additionally, since the underwriting criteria are input to this unified module, the underwriting criteria can be processed more efficiently as compared to inputting the underwriting criteria data to each underlying module separately.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for compatibility analysis using clustered data, comprising:
clustering a plurality of underwriting criteria indicated in underwriting criteria data with respect to a plurality of modules, wherein each underwriting criterion of the plurality of underwriting criteria is clustered into a respective module of the plurality of modules;
generating a unified module based on the plurality of modules;
applying the unified module to the plurality of underwriting criteria, wherein the unified module outputs a unified score for the plurality of modules; and
generating a compatibility level score between a first entity and a second entity based on at least one requirement of the first entity, at least one dataset storing entity characteristics of a plurality of entities including the second entity, and the unified score output by the unified module.

2. The method of claim 1, further comprising:
applying at least one extraction rule to the underwriting criteria data in order to extract the plurality of underwriting criteria, wherein the at least one extraction rule defines underwriting criteria to be extracted for each module with respect to characteristics of the underwriting criteria data.

3. The method of claim 1, further comprising:
determining whether the second entity is compatible with the first entity based on the compatibility level score, wherein the second entity is compatible with the first entity when the compatibility level score is above a threshold.

4. The method of claim 1, wherein the first entity is a lender, wherein the second entity is a credit product associated with a real-estate property, wherein the characteristics of the second entity includes characteristics of the real-estate property and of a potential borrowing entity associated with the real-estate property, wherein the at least one requirement includes at least one requirement for establishing credit for purchasing the real-estate property.

5. The method of claim 1, wherein the first entity is a potential buyer, wherein the second entity is a real-estate property, wherein the characteristics of the second entity includes characteristics of the real-estate property, wherein the at least one requirement includes at least one requirement for purchasing the real-estate property.

6. The method of claim 1, wherein generating the compatibility score further comprises:
applying a machine learning model to the at least one requirement of the first entity, the at least one dataset, and the unified score output by the unified module, wherein the compatibility score is output by the machine learning model.

7. A non-transitory computer readable medium having stored thereon instructions for causing a processing circuitry to execute a process, the process comprising:
clustering a plurality of underwriting criteria indicated in underwriting criteria data with respect to a plurality of modules, wherein each underwriting criterion of the plurality of underwriting criteria is clustered into a respective module of the plurality of modules;
generating a unified module based on the plurality of modules;
applying the unified module to the plurality of underwriting criteria, wherein the unified module outputs a unified score for the plurality of modules; and
generating a compatibility level score between a first entity and a second entity based on at least one requirement of the first entity, at least one dataset storing entity characteristics of a plurality of entities including the second entity, and the unified score output by the unified module.

8. A system for compatibility analysis using clustered data, comprising:
a processing circuitry; and
a memory, the memory containing instructions that, when executed by the processing circuitry, configure the system to:
cluster a plurality of underwriting criteria indicated in underwriting criteria data with respect to a plurality of modules, wherein each underwriting criterion of the plurality of underwriting criteria is clustered into a respective module of the plurality of modules;
generate a unified module based on the plurality of modules;
apply the unified module to the plurality of underwriting criteria, wherein the unified module outputs a unified score for the plurality of modules; and
generate a compatibility level score between a first entity and a second entity based on at least one requirement of the first entity, at least one dataset storing entity characteristics of a plurality of entities including the second entity, and the unified score output by the unified module.

9. The system of claim 8, wherein the system is further configured to:
apply at least one extraction rule to the underwriting criteria data in order to extract the plurality of underwriting criteria, wherein the at least one extraction rule defines underwriting criteria to be extracted for each module with respect to characteristics of the underwriting criteria data.

10. The system of claim 8, wherein the system is further configured to:
determine whether the second entity is compatible with the first entity based on the compatibility level score, wherein the second entity is compatible with the first entity when the compatibility level score is above a threshold.

11. The system of claim 8, wherein the first entity is a lender, wherein the second entity is a credit product associated with a real-estate property, wherein the characteristics of the second entity includes characteristics of the real-estate property and of a potential borrowing entity associated with the real-estate property, wherein the at least one requirement includes at least one requirement for establishing credit for purchasing the real-estate property.

12. The system of claim 8, wherein the first entity is a potential buyer, wherein the second entity is a real-estate property, wherein the characteristics of the second entity includes characteristics of the real-estate property, wherein the at least one requirement includes at least one requirement for purchasing the real-estate property.

13. The system of claim 8, wherein the system is further configured to:
apply a machine learning model to the at least one requirement of the first entity, the at least one dataset, and the unified score output by the unified module, wherein the compatibility score is output by the machine learning model.
